(19) United States
(12) Patent Application Publication
(10) Pub. No.: US 2024/0016680 A1
(43) Pub. Date: Jan. 18, 2024

(54) WHEELCHAIR STRUCTURE FOR PREVENTING PRESSURE ULCERS

(71) Applicants: Hsin-Pei Yang, Tainan City (TW); Kuan-Yu Chen, Tainan City (TW); Yu-En Liu, Tainan City (TW); Yu-Hsuan Wu, Tainan City (TW); Siou-Ci Yeh, Tainan City (TW)

(72) Inventors: Hsin-Pei Yang, Tainan City (TW); Kuan-Yu Chen, Tainan City (TW); Yu-En Liu, Tainan City (TW); Yu-Hsuan Wu, Tainan City (TW); Siou-Ci Yeh, Tainan City (TW)

(21) Appl. No.: 17/887,547

(22) Filed: Aug. 15, 2022

(30) Foreign Application Priority Data
Jul. 13, 2022 (TW) 111126232

(51) Int. Cl. A61G 5/10; A61G 5/12; A61G 5/14

(52) U.S. Cl. CPC A61G 5/1091; A61G 5/124; A61G 5/128; A61G 5/14

(57) ABSTRACT

A wheelchair structure for preventing pressure ulcers is disclosed. A lifting mechanism is mounted under a seat cushion of a wheelchair, and a knee support is disposed on the front of a seat cushion. When the lifting mechanism lifts the seat cushion, proximal ends of tibias of a user can just lean on the knee support, and a foot pedal of the wheelchair can make the user have a posture with bent knees and in a shape of “<”, so that the user can change a sitting posture to prevent pressure ulcers caused by long-term pressure on the buttocks when sitting in the wheelchair.

### BACKGROUND OF THE INVENTION

### 1. Field of the Invention

The present invention relates to a wheelchair structure for preventing pressure ulcers; in the present invention, a lifting mechanism is mounted under a seat cushion of a wheelchair, and a knee support is disposed on the front of a seat cushion, and when the lifting mechanism lifts the seat cushion, proximal ends of tibias of a user can just lean on the knee support, and a foot pedal of the wheelchair can make the user have a posture with bent knees and in a shape of “<”, so that the user can change a sitting posture to prevent pressure ulcers caused by long-term pressure on the buttocks when sitting in the wheelchair.

### 2. Description of the Related Art

People sitting on wheelchairs for long periods of time are inconvenient to move their bodies, so their buttocks are under pressure for a long time. As shown in FIG. 1, the pressure is concentrated and accumulated on rear parts of buttocks, so long-term sitting may cause secondary injuries such as pressure ulcers and waist discomfort.

Most of the conventional wheelchairs for preventing pressure ulcers are equipped with a set of knee rods for stopping proximal ends of tibias of a user in front of a seat cushion of the wheelchair. When the seat cushion is lifted, the proximal ends of the tibias of user can lean on the set of knee rods, and the user can exert force with hands or use external mechanical power to transfer a support part to soles and knees of the user and the user also keeps the center of gravity on the upper body, so that the buttocks of the user can be moved away from the seat cushion to reduce pressure.

However, the above-mentioned conventional wheelchair for preventing pressure ulcers has some disadvantages as follows.

First, It is quite laborious and needs other's assistance to use the above-mentioned conventional wheelchair.

Secondly, for a user whose foot or lower knee is amputated, the above-mentioned knee rod is unable to support and fasten the user's body, so the user may slip from the wheelchair to be damaged.

Therefore, how to solve the problem caused by the above-mentioned conventional wheelchair structure is a key issue for researchers.

### SUMMARY OF THE INVENTION

An objective of the present invention is to provide a wheelchair structure for preventing pressure ulcers, a lifting mechanism is mounted under a seat cushion of a wheelchair, and a knee support is disposed on the front of a seat cushion, when the lifting mechanism lifts the seat cushion, proximal ends of tibias of a user can just lean on the knee support, and a foot pedal of the wheelchair can make the user have a posture with bent knees and in a shape of “<”, so that the user can change a sitting posture to prevent pressure ulcers caused by long-term pressure on the buttocks when sitting in the wheelchair.

In order to achieve the objective, the present invention provides a wheelchair structure including a wheelchair frame, two knee supports, a foot pedal, and two limit rods.

The wheelchair frame includes front wheels and rear wheels configured for movement and disposed on two sides thereof, wherein the wheelchair frame is assembled with a seat part and a chair back, armrests are disposed on left and right sides of the seat part, respectively, wherein a lifting mechanism is disposed under the seat part and configured to push the seat part, so that the seat part is lifted by the lifting mechanism. The wheelchair frame includes a base frame disposed under the seat part, the base frame is configured to assemble with the lifting mechanism and comprises a first shaft coupling part disposed on a front end thereof. The two knee supports are arranged in symmetry and disposed below a front end of the seat part. The foot pedal includes a pedal linkage and a pedal, wherein an end of the pedal linkage is disposed on the pedal, and another end of the pedal linkage is connected under the seat part, wherein the seat part is pivotally connected to the chair back through a rotation shaft, the seat part comprises an active part connected to the lifting mechanism, and driven parts disposed on two sides of the active part, respectively. The two knee supports are disposed under the active part of the seat part through a connection base, and each of the two knee supports comprise a stopper that is pivotable, each of the two stoppers is connected to a telescopic adjustment device, and the telescopic adjustment devices are configured to adjust stop positions of the two knee supports for a user standing up to reduce pressure. A front end of the connection base is pivoted to an end of a pedal linkage, another end of the pedal linkage is connected to a front end of the pedal, the connection base is mounted under the seat part and configured to connect to the telescopic adjustment devices, the connection base has an auxiliary linkage disposed on a rear end thereof, and the other end of the auxiliary linkage is pivotally connected to the first shaft coupling part of the base frame. The two limit rods are arranged in symmetry and mounted on two sides of the front end of the wheelchair frame, respectively, wherein the two limit rods are configured to support and stop one of the driven parts, so as to limit rotations of the driven parts within a limited angle and support legs of the user. When the lifting mechanism is activated to push the active part of the seat part, the active part of the seat part is lifted, the rotation shaft drives the two driven parts to incline downwardly, so as to release pressure on thighs and buttocks of the user sitting on the seat part, the limit rods limit the rotation angle of the driven part and support the legs of the user, and the active part is moved upwardly to make proximal ends of tibias of the user move towards the front of the wheelchair, so that the proximal ends of the tibias lean on the knee support, the driven parts are inclined to press downwardly, so that the pedal linkage drives the foot pedal to rotate and hook backwardly toward the base frame, the telescopic adjustment devices adjusts a standing position and distance of the user, to make the user have a posture with knees bent and in the shape of “<”, thereby achieving an effect of reducing the pressure on the user's buttocks when the user sits in the wheelchair.

In an embodiment of the present invention, one of the seat part or the chair back has a seat belt disposed thereon.

In an embodiment of the present invention, the lifting mechanism is a hydraulic lifter or a pneumatic lifter configured to control a lifting height by a controller.

In an embodiment of the present invention, the lifting mechanism is a jack configured to control a lifting height by being rotated by a wrench.

According to above-mentioned description, the present invention has features and effects briefly described as follows.

First, the present invention can lift the seat part by the lifting mechanism, and then make the user's thighs and buttocks naturally relax with gravity during the lifting action by the pivoting functions of the active part and the driven part, so as to reduce pressure and prevent pressure ulcers.

Secondly, the knee support cooperating with the foot pedal can locate the user's standing distance at the proximal ends of the tibias and the lower body thereof, and the user has a posture with bent knee and in a shape of “<”, to achieve the effect of enabling the user to half stand up on a wheelchair to reduce the pressure on the buttocks. For the user whose foot or lower leg is amputated, the present invention is also able to achieve the effect of reducing pressure on buttocks.

### BRIEF DESCRIPTION OF THE DRAWINGS

The structure, operating principle and effects of the present invention will be described in detail by way of various embodiments which are illustrated in the accompanying drawings.

FIG. 1 is a schematic view of sitting pressure distribution in prior art.

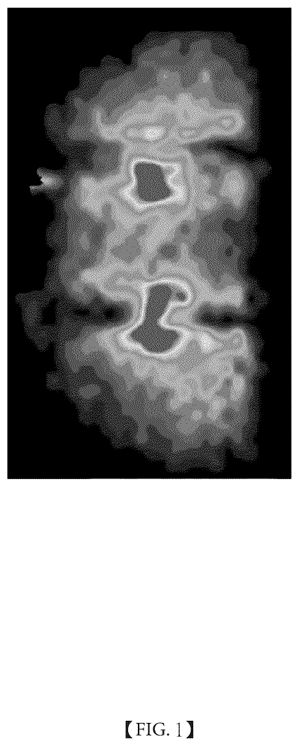

FIG. 2 is a perspective view of a wheelchair structure of the present invention.

FIG. 3 is a perspective view of the wheelchair structure of FIG. 2, when viewed from another angle.

FIG. 4 is a perspective view of a wheelchair structure of the present invention, when viewed from another angle.

FIG. 5 is a structural side view of a wheelchair structure without front wheels and rear wheels, according to the present invention.

FIG. 6 is a schematic view showing an operation of lifting a seat part, according to the present invention.

FIG. 7 is a schematic view showing an operation of a knee support, according to the present invention.

FIG. 8 is a schematic view showing an operation of a foot pedal, according to the present invention.

FIG. 9 is a schematic structural view of a wheelchair of the present invention in use.

FIG. 10 is a schematic view of sitting pressure distribution, when a seat part of the present invention is lifted.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

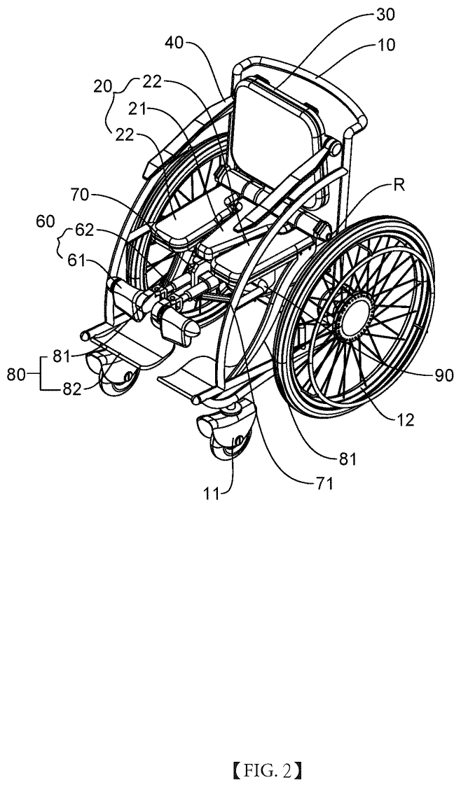

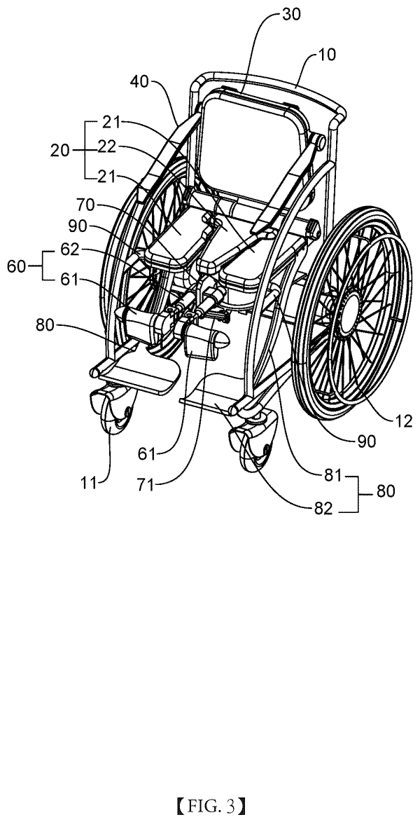

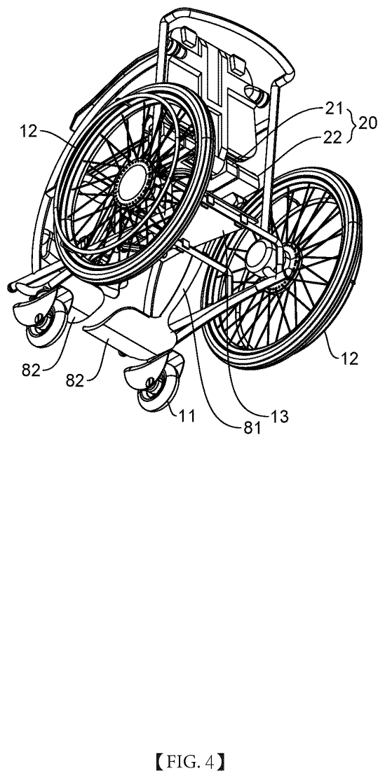

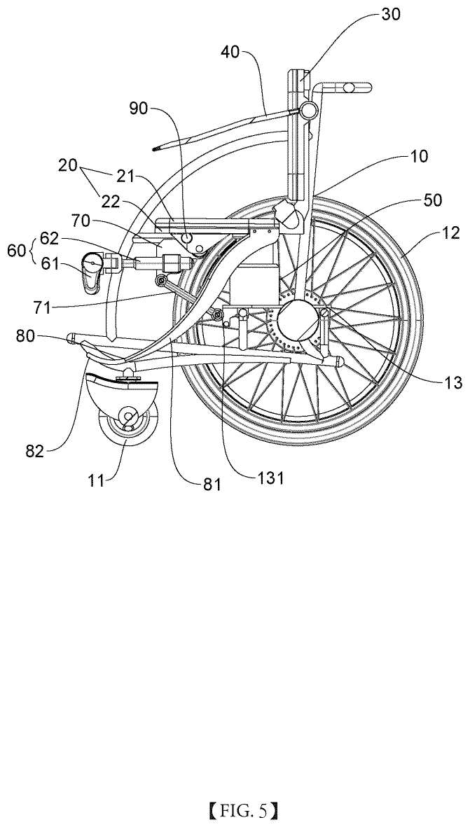

Please refer to FIGS. 2 to 5, which show a wheelchair structure for preventing pressure ulcers of the present invention. The wheelchair structure includes a wheelchair frame 10, knee supports 60 arranged in symmetry, a foot pedal 80, and limit rods 90 arranged in symmetry.

The wheelchair frame 10 includes front wheels 11 and rear wheels 12 configured to move and disposed on two sides thereof, respectively. The wheelchair frame 10 is configured to assemble with a seat part 20 and a chair back 30. Armrests 40 are disposed on left and right sides of the seat part 20. The wheelchair frame 10 includes a lifting mechanism 50 configured to push the seat part 20 and disposed under the seat part 20, so that the seat part 20 can be lifted by the lifting mechanism 50.

Please refer to FIGS. 2, 5 and 6. The seat part 20 is pivotally connected to the chair back 30 through a rotation shaft R, and the seat part 20 includes an active part 21 connected to the lifting mechanism 50, and driven parts 22 disposed on two sides of the active part 21, respectively. In an embodiment of the present invention, one of the seat part 20 and the chair back 30 is provided with a seat belt, which is not shown in figures.

As shown in FIGS. 2 to 6, the wheelchair frame 10 includes a base frame 13 disposed under the seat part 20 and configured to assemble with the lifting mechanism 50, and the base frame 13 includes a first shaft coupling part 131 disposed on a front end thereof. In this embodiment shown in FIGS. 2 to 6, the lifting mechanism 50 is a hydraulic lifter that controls a lifting height by a controller to lift the seat part 20 without other's assistance; in an embodiment of the present invention, the lifting mechanism 50 can be a jack that controls the lifting height by being rotated by a wrench. Furthermore, the lifting mechanism 50 can be a lifter that moves the seat part 20 upwardly or downwardly to control the height of the seat part 20 by an electric motor rotating gears through the electric motor; in an embodiment, the lifting mechanism can be a lifter that moves the seat part 20 upwardly or downwardly to control the height of the seat part 20 by an electric motor rotating a led screw to guide the nut to move upwardly or downwardly.

Please refer to FIGS. 2 to 4. Two knee supports 60 arranged in symmetry are disposed under a front end of the seat part 20, the knee supports 60 are horizontally disposed below the front end of the seat part 20 through a connection base 70. The knee support 60 include two stoppers 61 that are pivotable, each stopper 61 is connected to a telescopic adjustment device 62 configured to adjust a moving distance of the stopper 61, so as to adjust a use posture of the user and a stop position of the knee supports 60.

Please refer to FIGS. 2 to 4. A foot pedal 80 includes a pedal linkage 81 and a pedal 82, an end of the pedal linkage 81 is disposed on a rear end of the pedal 82, and another end of the pedal linkage 81 is connected under the seat part 20. An angle of the foot pedal 80 can be changed along with the lifting operation of the lifting mechanism 50.

As shown in FIGS. 2 to 4, the connection base 70 is mounted under the seat part 20, and the connection base 70 is configured to connect to the telescopic adjustment device 62; in addition, the connection base 70 has an auxiliary linkage 71 disposed on a rear end thereof, and another end of the auxiliary linkage 71 is pivotally connected to the first shaft coupling part 131 of the base frame 13.

As shown in FIGS. 2, 3 and 5, the limit rods 90 arranged in symmetry are mounted on two sides of the front end of the wheelchair frame 10, and each of the limit rods 90 is configured to support and stop the driven part 22, so as to limit the rotation of the driven parts 22 within a limited angle and support legs of the user.

The above is an introduction to the compositions and relative positions of the components of the wheelchair structure of the present invention, and the actual operation and the functions and advantages of the present invention will be described in the following paragraphs.

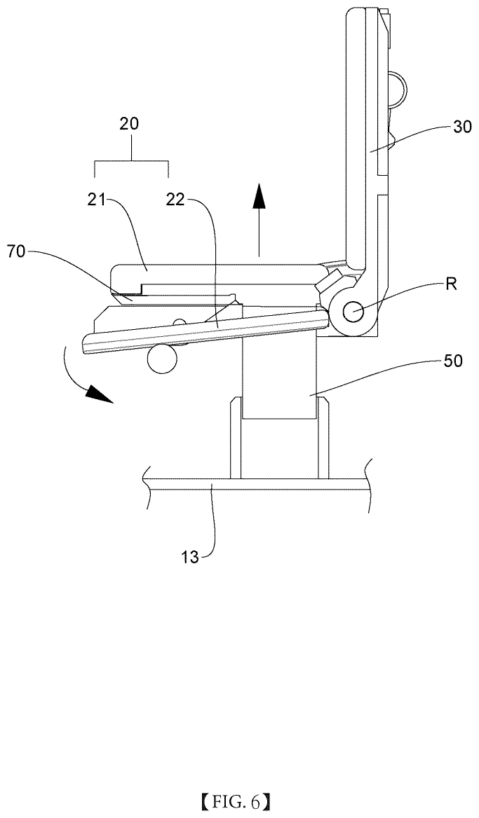

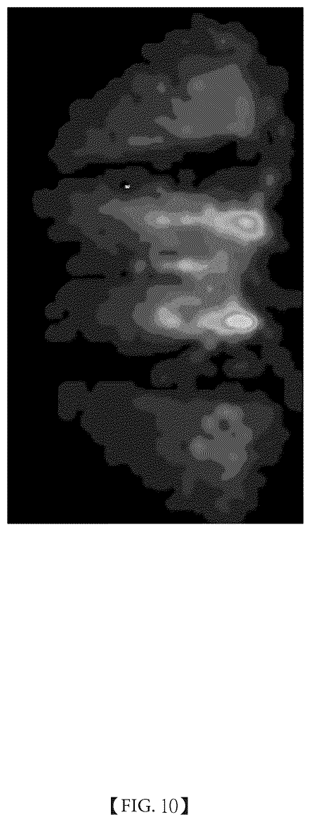

As shown in FIG. 6, when the lifting mechanism 50 is activated to push the active part 21 of the seat part 20, the active part 21 of the seat part 20 is lifted, the rotation shaft R can drive two driven parts 22 to incline downwardly, so as to release pressure on thighs and buttocks of the user sitting on the seat part 20. Each of the limit rods 90 limits a rotation angle of the driven part 22 and supports the leg of the user. FIG. 10 shows the sitting pressure distribution after the seat part 20 is lifted, and it can be observed in FIG. 10 that the pressure distribution on the buttocks and thighs is relatively dispersed, so that the effect of reducing pressure can be indeed achieved.

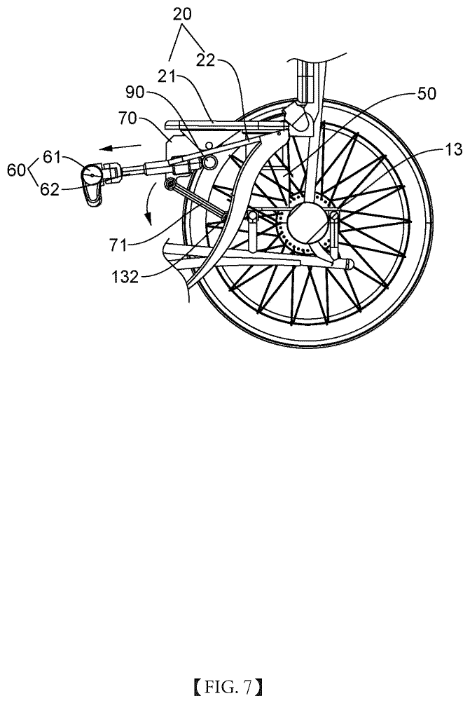

As shown in FIG. 7, since the active part 21 is moved upwardly to make proximal ends of tibias of the user move towards the front of the wheelchair, and the connection base 70 is also driven to move upwardly by the active part 21, and the telescopic adjustment device 62 is rotated to extend a length thereof, so that the proximal ends of the tibias of the user can lean on the stopper 61 of the knee support 60, and the position of the knee support 60 can be adjusted by the telescopic adjustment devices 62, so as to adjust the standing distance and position of the user.

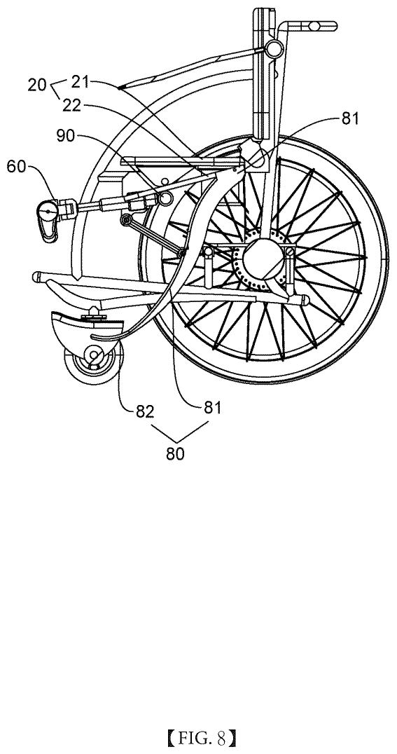

As shown in FIG. 8, the driven part 22 is inclined to press downwardly, the pedal linkage 81 drives the foot pedal 80 to rotate and hook backwardly toward the base frame 13, the telescopic adjustment device 62 adjusts the standing position and distance of the user, so that the user can have a posture with bent knees and in the shape of “<”, thereby achieving an effect of reduce the pressure on the user's buttocks when the user sits in the wheelchair.

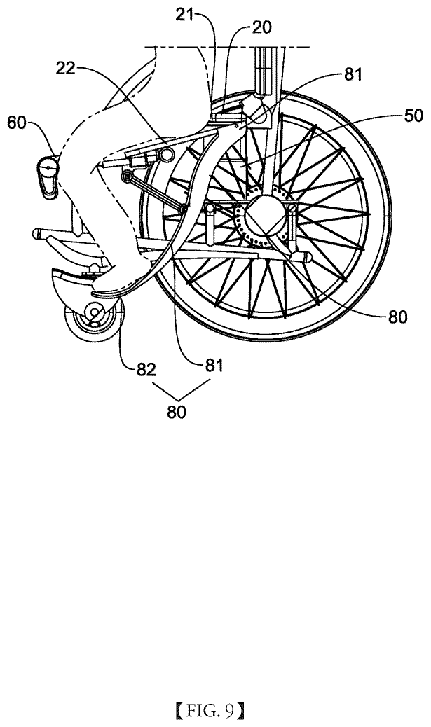

Please refer to FIG. 9, which is a schematic view of actual use of the present invention. When the lifting mechanism 50 lifts the seat part 20, the proximal ends of the tibias of the user can just lean on the knee support 60; in addition, with the foot pedal 80, the user can have the posture with bent knees and in the shape of “<”, so that, the user can change a sitting posture to prevent pressure ulcers caused by long-term pressure on the buttocks when sitting in the wheelchair.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A wheelchair structure for preventing pressure ulcers, comprising:
a wheelchair frame, comprising front wheels and rear wheels configured for movement and disposed on two sides thereof, wherein the wheelchair frame is assembled with a seat part and a chair back, armrests are disposed on left and right sides of the seat part, respectively, wherein a lifting mechanism is disposed under the seat part and configured to push the seat part, so that the seat part is lifted by the lifting mechanism;
wherein the wheelchair frame comprises a base frame disposed under the seat part, the base frame is configured to assemble with the lifting mechanism and comprises a first shaft coupling part disposed on a front end thereof;
two knee supports arranged in symmetry and disposed below a front end of the seat part;
a foot pedal, comprising a pedal linkage and a pedal, wherein an end of the pedal linkage is disposed on the pedal, and another end of the pedal linkage is connected under the seat part, wherein the seat part is pivotally connected to the chair back through a rotation shaft, the seat part comprises an active part connected to the lifting mechanism, and driven parts disposed on two sides of the active part, respectively;
wherein the two knee supports are disposed under the active part of the seat part through a connection base, and each of the two knee supports comprise a stopper that is pivotable, each of the two stoppers is connected to a telescopic adjustment device, and the telescopic adjustment devices are configured to adjust stop positions of the two knee supports for a user standing up to reduce pressure;
wherein a front end of the connection base is pivoted to an end of a pedal linkage, another end of the pedal linkage is connected to a front end of the pedal, the connection base is mounted under the seat part and configured to connect to the telescopic adjustment devices, the connection base has an auxiliary linkage disposed on a rear end thereof, and the other end of the auxiliary linkage is pivotally connected to the first shaft coupling part of the base frame; and
two limit rods, arranged in symmetry and mounted on two sides of the front end of the wheelchair frame, respectively, wherein the two limit rods are configured to support and stop one of the driven parts, so as to limit rotations of the driven parts within a limited angle and support legs of the user;
when the lifting mechanism is activated to push the active part of the seat part, the active part of the seat part is lifted, the rotation shaft drives the two driven parts to incline downwardly, so as to release pressure on thighs and buttocks of the user sitting on the seat part, the limit rods limit the rotation angle of the driven part and support the legs of the user, and the active part is moved upwardly to make proximal ends of tibias of the user move towards the front of the wheelchair, so that the proximal ends of the tibias lean on the knee support, the driven parts are inclined to press downwardly, so that the pedal linkage drives the foot pedal to rotate and hook backwardly toward the base frame, the telescopic adjustment devices adjusts a standing position and distance of the user, to make the user have a posture with knees bent and in the shape of “<”, thereby achieving an effect of reducing the pressure on the user's buttocks when the user sits in the wheelchair.

2. The wheelchair structure for preventing pressure ulcers according to claim 1, wherein one of the seat part or the chair back has a seat belt disposed thereon.

3. The wheelchair structure for preventing pressure ulcers according to claim 1, wherein the lifting mechanism is a hydraulic lifter or a pneumatic lifter configured to control a lifting height by a controller.

4. The wheelchair structure for preventing pressure ulcers according to claim 1, wherein the lifting mechanism is a jack configured to control a lifting height by being rotated by a wrench.

5. The wheelchair structure for preventing pressure ulcers according to claim 1, wherein the lifting mechanism is a motor drive lifter configured to control a lifting height by a controller.

6. The wheelchair structure for preventing pressure ulcers according to claim 1, wherein the lifting mechanism is moved along the rack by an electric motor rotating gears, so as to drive the seat part to move upwardly or downwardly.

7. The wheelchair structure for preventing pressure ulcers according to claim 1, wherein the lifting mechanism moves the seat part upwardly or downwardly by an electric motor rotating a led screw.
